(19) United States
(12) Patent Application Publication
(10) Pub. No.: US 2016/0015021 A1
(43) Pub. Date: Jan. 21, 2016

(54) SNAKE BAIT TRAP

(71) Applicant: Andre Green, Pittsburgh, PA (US)

(72) Inventor: Andre Green, Pittsburgh, PA (US)

(21) Appl. No.: 14/611,230

(22) Filed: Jan. 31, 2015

Related U.S. Application Data
(63) Continuation-in-part of application No. 14/544,013, filed on Nov. 14, 2014, now abandoned.
(60) Provisional application No. 62/026,684, filed on Jul. 20, 2014.

(51) Int. Cl. A01M 25/00; A01M 23/00

(52) U.S. Cl. CPC A01M 25/004; A01M 23/00

(57) ABSTRACT

There is claimed a snake trap comprising an elongated tube having two open ends with a larger circumference middle section or belly into which is placed poisonous bait for consumption by the snake that enters. Preferably, it is clear and made of plastic or glass with camouflage type decorations for resembling grass, sand or garden-like appearances. A locking access door may be included and an optional carrying handle. Optionally, each open end can be fitted with directional guards for discouraging a snake from exiting the trap once it has entered the same.

### CROSS-REFERENCE TO RELATED APPLICATIONS

This is a continuation-in-part of application Ser. No. 14/544,013, filed on Nov. 14, 2014, which is a perfection of Provisional Application No. 62/026,684, filed on Jul. 20, 2014, both disclosures of which are fully incorporated by reference herein.

### FIELD OF THE INVENTION

The present invention pertains to snake killing and related traps. More particularly, it relates to a snake trap with an area for holding for holding poisonous bait that only the snake can access.

Snakes can generate fear and cause injury to people and animals. It would be a benefit, therefore, to have a snake trap that could be used to trap and dispose of. Alternately, this trap can dispense poisonous bait that the snake can digest and then die elsewhere.

Known traps for snakes and other animals include those set forth in: Slauth U.S. Pat. No. 2,573,228, Otterson U.S. Pat. No. 4,244,134, Smith U.S. Pat. No. 4,763,439, Henning U.S. Pat. No. 5,067,271 and Fore U.S. Pat. No. 6,023,878.

### SUMMARY OF THE INVENTION

It is an object of this invention to provide a trap that captures the snake in a container/housing. It is a further object to provide a snake trap that includes an entrance tube in connection with a trap compartment to increase the likelihood of snake capture and containment. Alternately, that compartment can house a poisonous bait that only the snake but no harmless animals (including family pets) can access before leaving the trap to die nearby or adjacent the trap.

It is a still further object of the invention to provide a snake trap that accomplishes some or all of the above objects in combination.

Accordingly, a snake trap is provided with a container/casing, or essentially an elongated tube having two open tube ends with a larger circumference middle section into which is positioned a poisonous bait for consumption by the snake that enters this tube. One preferred embodiment uses a tube that resembles the cover for a hurricane lamp. Preferably, it is clear and made of glass or plastic. So as to not roll about once baited, the casing can be mounted on a wooden, metal or plastic stand.

More preferred versions include camouflage type decorations to the casing resembling grass, sand, garden-type appearances. To better access the casing center, a locking access door may be included and an optional carrying handle for toting the “used” casing (containing one's catch) for disposal. Another variation would include directional guards (such as plastic feelers) at both ends for discouraging the snake that enters this trap from wiggling back out again.

### BRIEF DESCRIPTION OF THE DRAWINGS

Further features, objectives and advantages for these inventions will become clearer when referring to the following detailed description made with reference to the accompanying drawings in which:

FIG. 1 is a side perspective view showing one embodiment of baited snake trap on its base/stand according to this invention;

FIG. 2 is a side view of a second embodiment with C-clamp ground securement and bait access door;

FIG. 3 is a side view of a third embodiment with entrapment means over the elongated tube entrance and exit portals;

FIG. 4 is a front longitudinal view of the embodiment at FIG. 3;

FIG. 5 is a side view showing an optional carrying handle variation for this invention;

FIGS. 6A-C are side views of various snake bait shapes; and

FIG. 7 is a front plan view of a second embodiment of securement means for use with the present invention.

### DESCRIPTION OF PREFERRED EMBODIMENTS

In FIG. 1, a first embodiment of snake trap is shown. In subsequent alternate embodiments, common components are consistently numbered through in the next hundred series. This invention, known as the Snake Killer™, is a trap for catching and killing snakes. The trap, generally 10, is meant to safely “hold” poisonous bait B inside a casing, containment or other elongated tubular housing 12 that only the targeted snake will be able to access. A snake will die after entering trap 10 and swallowing the poisonous bait B. However, it will NOT allow accidental access by family pets, children or the like.

The bait to be used with this invention may resemble many objects like a mouse, rat, other small mammal, reptile, salamander, etc. It will also work with baited poisonous eggs.

The housing 12 (or case) should be clear and made or plastic or a hardened glass. One embodiment has the shape of a hurricane lamp (i.e., with a thicker belly or middle section 14) and additionally beveling outwardly at both (opposite) ends, 16L and R as shown, the open entrance and exit to this trap 10. This case is meant to keep other animals like dogs and cats from getting into, or otherwise eating the poisonous bait kept inside. It will also keep children and babies away from the bait. In FIG. 1, bait B is in the shape of a gummy mouse or rat that has poison included therein.

For keeping a baited trap 10 from rolling about, the invention provides a “bottom” or flat base 20 made from wood, metal or plastic. See, FIGS. 1 and 4. With the aforementioned clear outer shell of main housing 12, it may be possible to add (via paint on or decals) decorations simulating yard grass (element 22 in FIG. 1), sand, rocks, a garden or other snake amenable environs.

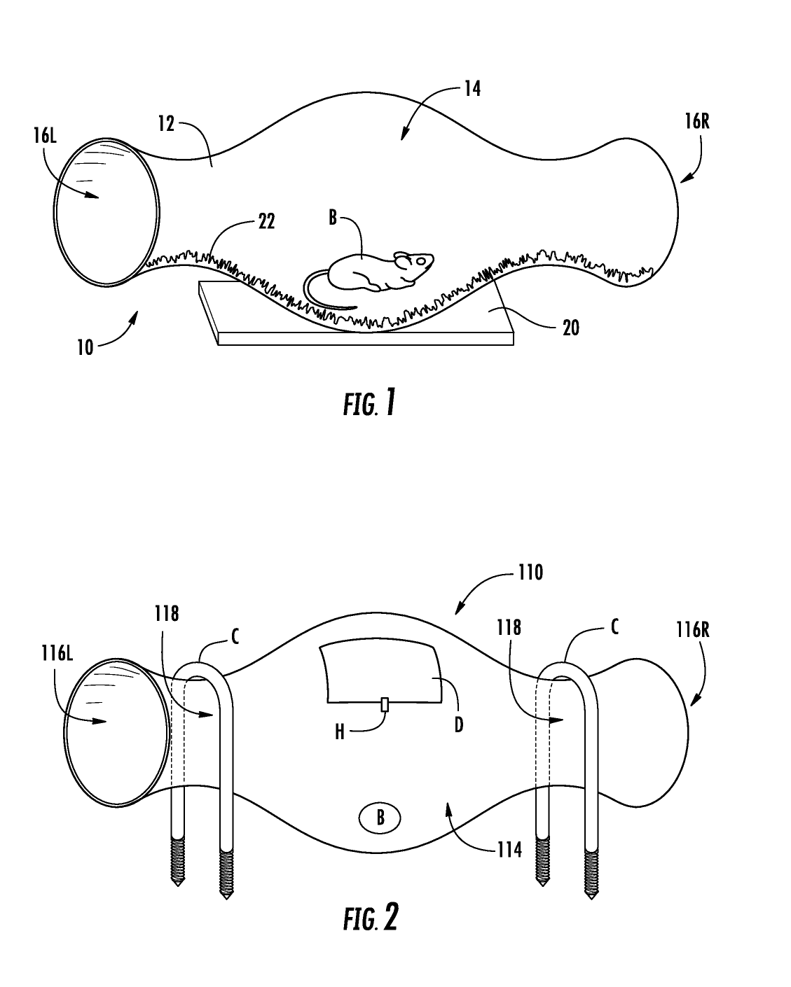

In the operation of this invention, it is expected that such a trap be placed in an area where snakes have been spotted/observed. Trap 110 of FIG. 2 is baited B and made for laying directly on the ground (rather than on a flat base). FIG. 2 further includes a lockable access door D, with its own hinge H for easier/better placement of baited poison inside. Once properly positioned in the user's lawn or garden, two representative C-clamp ground securement means (element C) can be situated over the thin neck regions 118 to the main tubular housing 112 of this first variation. With bait access door D, this model can be emptied and reused as needed.

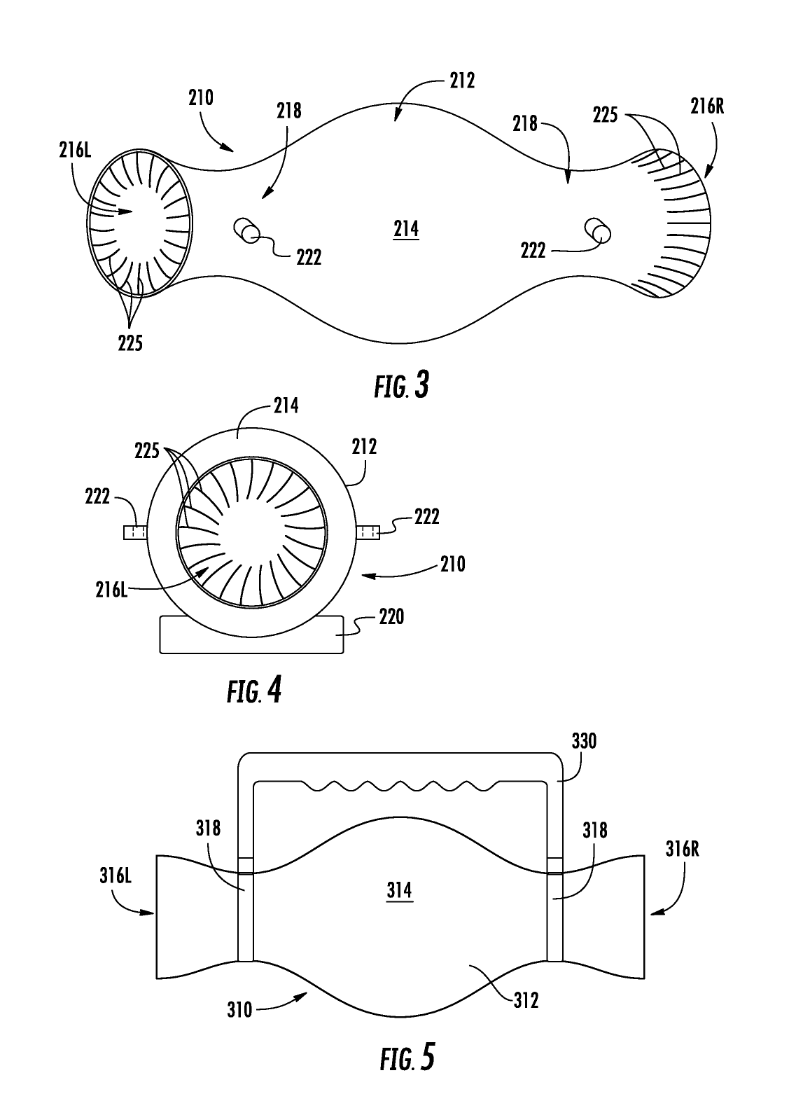

In the next alternative at FIGS. 3 and 4, the trap 210 can be fitted with a plurality of eyelets 222 through which one or more ground spikes/nails (not shown) may be hammered for making sure the baited trap 210 will not move or otherwise roll away if one elects NOT to use a trap base 220 as otherwise shown in FIG. 4. The variation at FIGS. 3 and 4 further includes a plurality of directional plastic guards or tines 225 designed for allowing the intended snake target to get into the trap 210; but once inside, he/she will be unable to reverse direction (especially after feeding on the bait) for otherwise exiting from either end.

As it is a clear casing, the targeted snake can spot the bait inside and enter from either end of an elongated tube trap and then feed on the bait B contained therein. In many cases, the size of the bait and/or dosage of poison will cause the snake to die contained in the trap proper. For that reason, FIG. 5 shows yet another alternate embodiment of trap 310 that has a handle 330, affixed over both neck portions 318 for easier carrying (and disposal) of a successfully used trap. Without any blocking tine ends, a snake may digest the poisonous bait and exit the trap in lesser, rare instances. But he/she won't wander far from it before dying.

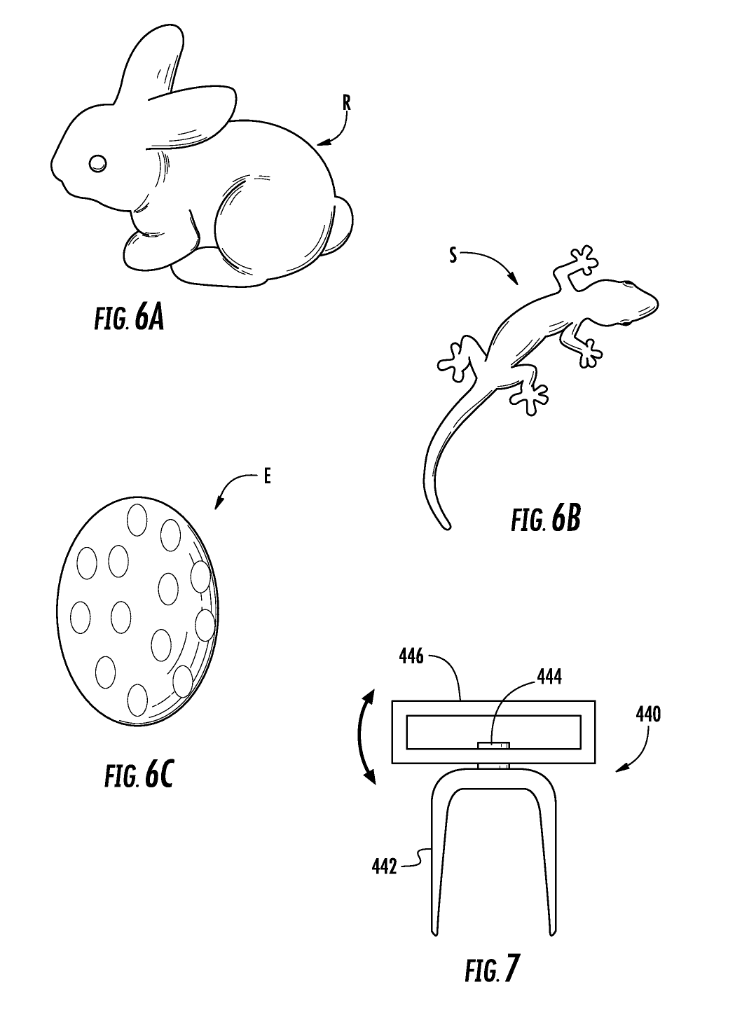

One preferred version of bait B is the gummy style animals that resemble animals that are sprayed, injected or otherwise dosed with a poison. These varieties can also be further sprayed with bug repellant-type insecticides. FIGS. 6A through C show various bait shapes for use with the trap of this invention: 6A is the shape of a gummy rabbit R; 6B a gummy salamander S and 6C an animal egg E.

FIG. 7 shows an alternate variation of ground securement means besides the C-clamp version shown in FIG. 2. In this variation, there are shown staples 440 having a C-shaped base 442, a central connector 444 that can be hammered upon for securing directly into the ground and an upper pull hand hole/or handle 446 that can be used for pulling up and removing the whole staple assembly 440 from the ground when no longer needed.

It is noted that the embodiment of the snake trap described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What is claimed is:

1. A snake bait trap comprising:
an elongated tube having an opening at at least one end and a central belly section into which a poisonous bait is placed.

2. The snake trap of claim 1, which includes an opening at both ends.

3. The snake trap of claim 1, which further includes a stand onto which the central belly section of the elongated tube can be rested for storage or use.

4. The snake trap of claim 1, which further includes a plurality of camouflage type decals or markings on a side of the central belly section of the elongated tube.

5. The snake trap of claim 1, which further includes a locking, bait access door.

6. The snake trap of claim 1, which further includes a carrying handle.

7. The snake trap of claim 1, wherein each end opening includes a directional guard for preventing a snake from exiting the snake trap therethrough.

8. The snake trap of claim 7, wherein the directional guard include a plurality of plastic spikes about a perimeter of the end opening, said plastic spikes all protruding inwardly toward the central belly section.

9. The snake trap of claim 1, which further includes ground securement means at one or both ends of the elongated tube.

10. The snake trap of claim 9 wherein the ground securement means include a plurality of c-clamps.

11. The snake trap of claim 9 wherein the elongated tube includes one or more eyelets and the ground securement means comprises a plurality of nails or spikes.

12. The snake trap of claim 1 wherein the elongated tube resembles a cover for a hurricane lamp.

13. The snake trap of claim 1 wherein the elongated tube is made from clear plastic.

14. The snake trap of claim 1 wherein the elongated tube is made from a break-resistant glass.

15. The snake trap of claim 1 wherein the poisonous bait for use therein resembles a small animal selected from the group consisting of a mouse, rat, salamander and a rabbit.

16. The snake trap of claim 1 wherein the poisonous bait for use therein resembles a small animal egg.

17. A snake bait trap comprising:
an elongated tube that resembles a hurricane lamp cover, said elongated tube having an opening at both ends with a central belly section between into which is placed poisonous bait.

18. The snake trap of claim 17, which further includes at least one of:
a stand onto which the central belly section of the elongated tube can be rested;
a plurality of camouflage type decals or markings on a side of the central belly section;
a locking, bait access door;
a carrying handle; and
ground securement means at one or both ends of the elongated tube.

19. The snake trap of claim 17, wherein each end opening includes a directional guard for preventing a snake from exiting the snake trap there through.

20. The snake trap of claim 17 wherein the elongated tube is made from clear plastic.
